(19) United States
(12) Patent Application Publication
(10) Pub. No.: US 2005/0257635 A1
(43) Pub. Date: Nov. 24, 2005

(54) Rack yoke assembly

(76) Inventors: Michael J. Damore, Sterling Heights, MI (US); Richard A. Stoll, Royal Oak, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/852,029

(22) Filed: May 24, 2004

(51) Int. Cl. F16H 1/04

(52) U.S. Cl. 74/422

(57) ABSTRACT

A rack yoke assembly supports a rack in a steering gear housing for a rack and pinion steering apparatus. The rack yoke assembly includes a carrier portion and a seat portion. The seat portion has an engaging surface that is configured to engage the rack. The seat portion and the carrier portion are structured to be assembled together to form the rack yoke assembly.

### BACKGROUND OF THE INVENTION

This invention relates in general to a rack and pinion steering apparatus, and more particularly relates to a yoke for supporting a rack in the rack and pinion steering apparatus.

A rack and pinion steering apparatus has a housing containing a rack and a pinion. The rack has a longitudinally extending row of rack teeth in meshing engagement with helical gear teeth on the pinion. The opposite ends of the rack project outward from the housing and are connected with a steering linkage and a corresponding pair of steerable vehicle wheels. The pinion is connected with the vehicle steering wheel by an input shaft and a torsion bar. When a steering maneuver is being performed the pinion rotates and the rack moves longitudinally. The housing also contains a spring loaded yoke that presses the rack against the pinion to maintain the rack teeth in meshing engagement with the gear teeth on the pinion.

### SUMMARY OF THE INVENTION

This invention relates to a rack yoke assembly that supports a rack in a steering gear housing for a rack and pinion steering apparatus. The rack yoke assembly includes a carrier portion and a seat portion. The seat portion has an engaging surface that is configured to engage the rack. The seat portion and the carrier portion are structured to be assembled together to form the rack yoke assembly.

The invention also relates to a system for assembling a rack yoke assembly for a rack and pinion steering apparatus. The system includes a carrier portion and a seat portion. The system has a plurality of differently sized seat portions. Each of the plurality of seat portions has an identifiable physical characteristic. One of the plurality of seat portions is selectable to be assembled with the carrier portion to form a rack yoke assembly.

The invention also relates to a method for assembling a rack yoke assembly for a rack and pinion steering apparatus including the steps of providing a carrier portion having a bore, providing a seat portion having a protrusion. The seat portion is configured to engage the rack of a rack and pinion steering apparatus. The protrusion is inserted into the bore to assemble the seat portion with the carrier portion.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a sectional view of a rack and pinion steering apparatus.

FIG. 2 is a cross-sectional view through Line 2-2 of the rack and pinion steering apparatus of FIG. 1 including a prior art rack yoke.

FIG. 3 is an exploded elevational view of a rack yoke assembly according to the present invention.

FIG. 4 is an elevational view of a partially assembled rack yoke assembly according to the present invention.

FIG. 5 is an elevational view of the assembled rack yoke according to the present invention.

FIG. 6 is a cross-sectional view of a portion of a rack and pinion steering assembly similar to that of FIG. 1 including the rack yoke assembly according to the present invention.

### DETAILED DESCRIPTION OF THE PREFERRED EMBODIMENT

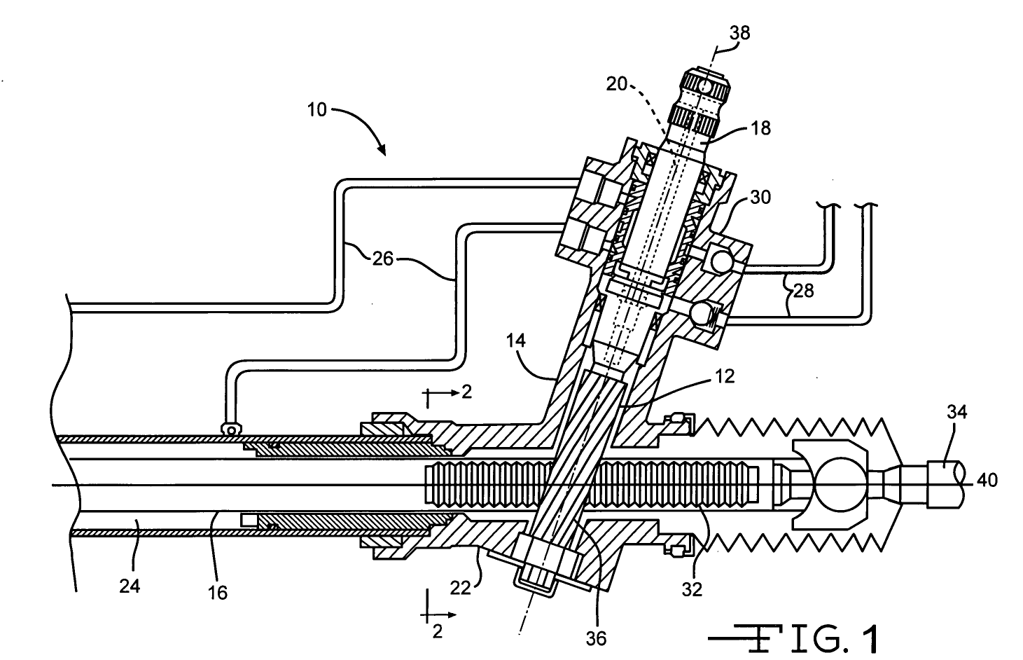

Referring now to the drawings, there is illustrated in FIG. 1 a portion of a generally conventional hydraulically assisted rack and pinion steering apparatus 10 having a pinion 12. The steering apparatus 10 further includes a housing 14, a rack 16, an input shaft 18, and a torsion bar 20. It can be appreciated that the steering apparatus 10 described below could be used in either a manually driven steering apparatus or a power assisted steering apparatus.

The housing 14 has a hydraulic valve section 30 and a transversely extending rack section 22 through which the rack 16 extends. A rack chamber 24 is defined in the rack section 22 of the housing 14. Hydraulic lines 26 provide fluid communication between the rack chamber 24 and the valve section 30 of the housing 14. Hydraulic conduits 28 provide fluid communication between the valve section 30 and a power steering pump (not shown).

A piston (not shown) is connected to the rack 16 and is disposed in the rack chamber 24. The piston separates the rack chamber 24 into two chambers such that hydraulic fluid can selectively be supplied to one of the opposed chambers depending on the steering maneuver being performed. The rack 16 includes a section having rack teeth 32. The rack teeth 32 are meshed with helical teeth 36, described further below, on the pinion 12 inside the housing 14. Opposite ends of the rack 16 are connected with steerable vehicle wheels (not shown) by pivotable tie rods, one of which is shown at 34 as is known in the art. When a steering maneuver is being performed, the pinion 12 rotates about the axis 38, and the rack 16 moves longitudinally along a horizontal axis 40.

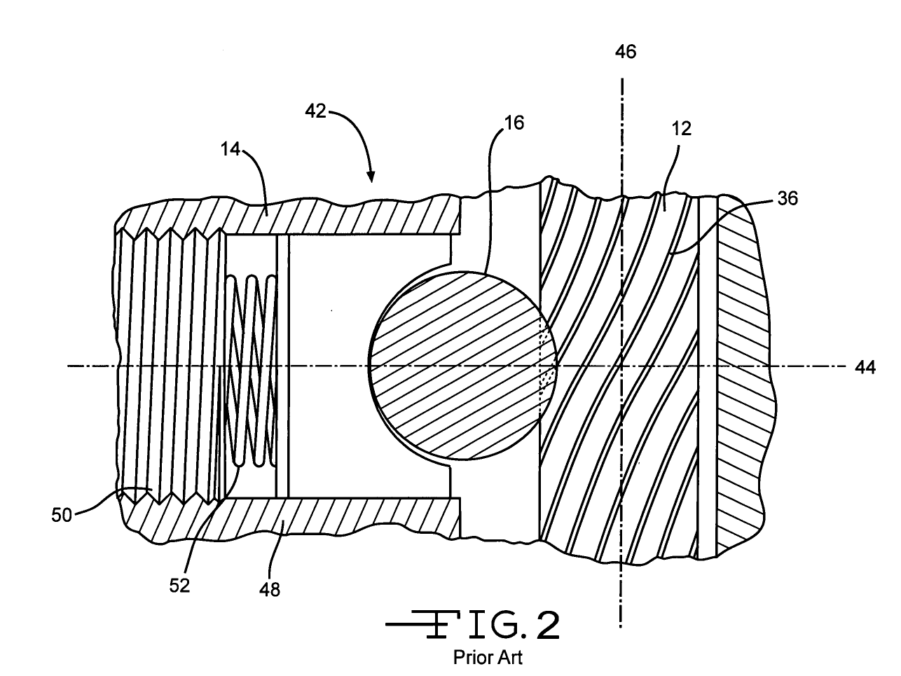

Illustrated in FIG. 2, there is shown a cross-sectional view through Line 2-2 of the rack and pinion steering apparatus 10 of FIG. 1 including a rack yoke, indicated generally at 42. The rack yoke 42 is a substantially cylindrical part centered on an axis 44 that is perpendicular to the axis 40 of the rack 16. As further shown in FIG. 2, the rack yoke 42 is contained in a cylindrical section 48 of the housing 14 between a closure cap 50 and the rack 12. A spring 52 is compressed between the rack yoke 42 and the closure cap 50. The spring 52 applies an axially directed preloading force which urges the rack yoke 42 forcefully against the rack 16 in a direction from left to right as viewed in FIG. 2. The rack yoke 42 in turn applies the preloading force to the rack 16 so as to hold the rack teeth 32 firmly in mesh with the helical teeth 36 on the pinion 12.

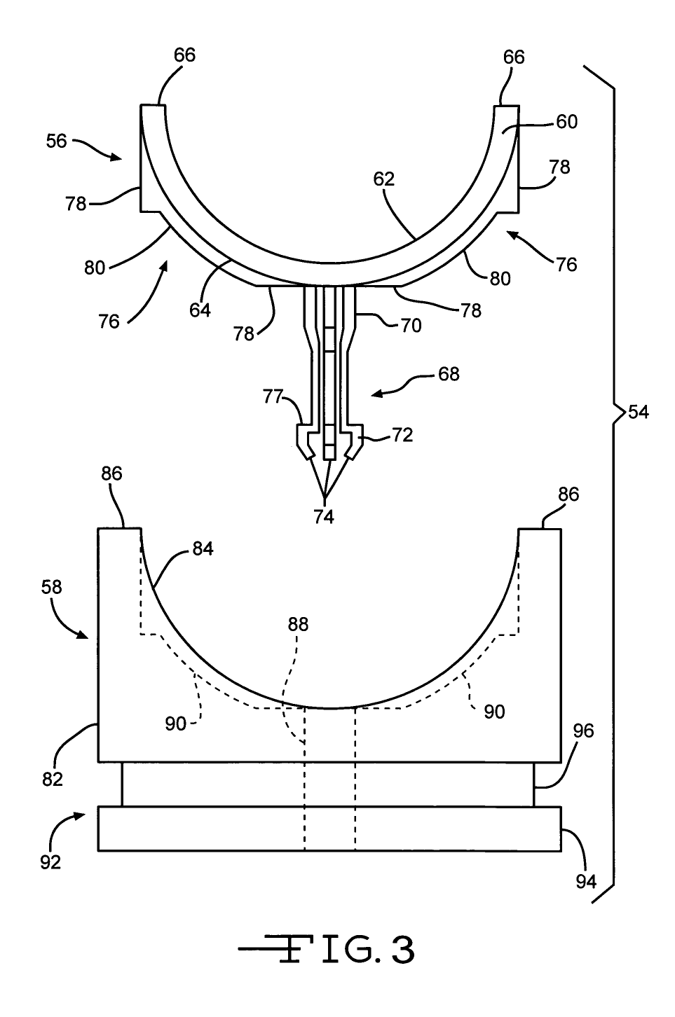

Illustrated in FIG. 3 is an exploded view of a rack yoke assembly 54 according to the present invention. As shown, there is a seat portion, indicated generally at 56 and a carrier portion, indicated generally at 58. The seat portion 56 includes a U-shaped body 60 that defines an upper rack engaging surface 62 and a lower surface 64. Both the rack engaging surface 62 and the lower surface 64 preferably are curved thereby forming the upper and lower portions of the U-shape of the body 60. It should be appreciated that the curved rack engaging surface 62 and lower surface 64 can be semi-circular, semi-elliptical, or arced. In addition, the rack engaging surface 62 can have any suitable shape that corresponds to the shape of the rack 16. As illustrated, the rack engaging surface 62 has a radius of curvature that is less than the radius of curvature of the lower surface 64. However, any combinations of curvatures can be used depending on the design requirements of the seat portion 56. In the preferred embodiment, substantially flat flanged portions 66 connect the outer edges of the upper rack engaging surface 62 with the outer edges of the lower surface 64. The rack engaging surface 62 of the body 60 comprises the surface that is in substantially direct engagement with the rack 16. The rack engaging surface 62 is the portion of the body 60 that is forced into contact with the rack 16 by the spring 52 as was described above. Therefore, it can be appreciated that the upper rack engaging surface 62 is shaped to closely match the surface of the rack 16 which it engages. The body 60 of the seat portion 56 can be made from a material such as a plastic, nylon, or Kevlar-based material, or can be coated with a Teflon or other low friction material. Both Teflon and Kevlar are products that are commercially available from and are registered trademarks of E. I. DuPont de Nemours and Co. of Wilmington, Del. It should be appreciated that any suitable material can be used to form the body 60 to provide a substantially low wear contact surface between the rack yoke assembly 54 and the rack 16.

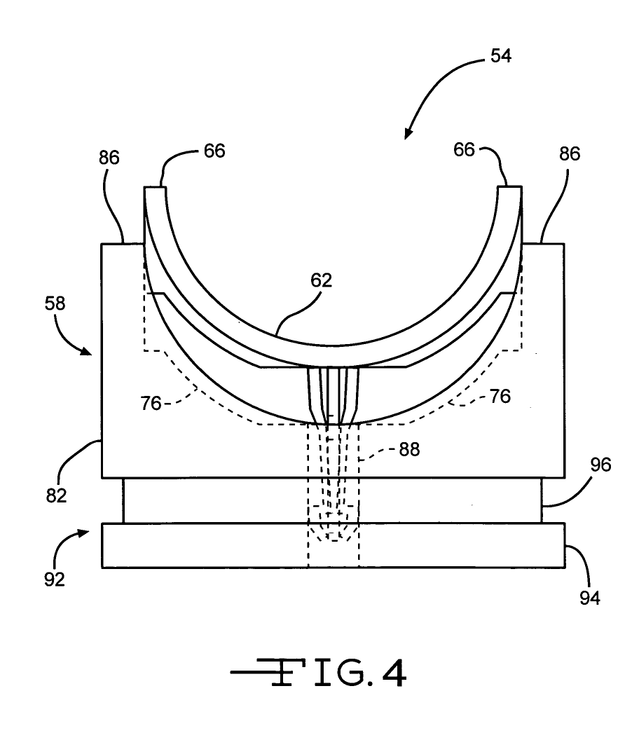

Extending from the lower surface 64 of the body 60 of the seat portion 56, and away from the upper rack engaging surface 62, is a protrusion 68. In the preferred embodiment, a first end 70 of the protrusion 68 is substantially centrally located on the lower surface 64. In addition, a second end 72 of the protrusion 68 is relatively wider than the first end 70 of the protrusion 68. The purpose of the protrusion 68 is to connect the seat portion 56 to the carrier portion 58, as will be described below with respect to the carrier portion 58. The protrusion 68 can have any suitable design. Particularly, there can be a plurality of protrusions 68 located at spaced apart positions along the lower surface 64 of the body 60. In the preferred embodiment, the protrusion 68 is comprised of multiple prongs 74. Although four prongs 74 are shown in FIG. 3, it can be appreciated that any number of prongs 74 can be used. Each of the prongs 74 is preferably spaced apart from adjacent prongs 74. It is also preferred that each of the prongs 74 is resilient such that one or more of the prongs 74 can be compressed together to reduce the space between the prongs 74 (as can be best seen in FIG. 4) for connection with the carrier portion 58. At a minimum, the second end of the protrusion 68 which constitutes the free ends of the prongs 74 is movable so as to reduce the overall outside profile of the protrusion 68 by reducing the space between adjacent prongs 74.

Also formed on the lower surface 64 of the body 60 is at least one ridge 76, and preferably a pair of opposed ridges 76. The ridges 76 preferably extend from the center of the lower surface 64 to the edge of the flanged portion 66. In addition, the ridges 76 taper from relatively reduced thickness portions 78 at the ends of the ridges 76 (at the center of the lower surface and the edge of the flanged portion) to relatively thicker portions 80 at the centers of the ridges 76. The width of the ridges 76 is preferably relatively narrower than the overall width of the body 60. In a further preferred embodiment, the width of the ridges 76 is approximately the same as the width of the protrusion 68. The purpose of the ridges 76 is to align the seat portion 56 with the carrier portion 58, as will be described below with respect to the carrier portion 58.

The carrier portion 58 is formed having a generally cylindrical body 82 molded from powdered metal, zinc cast, or a high impact/high temperature plastic. It should be appreciated that the carrier portion 58 can be made from any suitable material. As described above, the cylindrical body 82 of the carrier portion 58 is sized and shaped to fit within the cylindrical section 48 of the housing 14. The carrier portion 58 has an upper face 84 that is generally U-shaped and substantially conforms to the shape of the lower surface 64 of the body 60 of the seat portion 56. In the preferred embodiment, the upper face 84 of the carrier portion 58 is designed to provide supporting engagement for the seat portion 56. The edges of the upper face 84 terminate in a pair of opposed generally flat flanged portions 86. Therefore, when the seat portion 56 is seated within the carrier portion 58, the flanged portions 66 of the seat portion 56 are adjacent the flanged portions 86 of the carrier portion 58. In the illustrated embodiment, the flanged portions 66 and 86 are shown to be substantially co-planar with each other when the rack yoke assembly 54 is assembled. However, such a structure is not required. In the preferred embodiment, a bore 88 is formed through the center of the carrier portion 58. It is further preferred that the bore 88 pass through the entire carrier portion 58 although such a design is not required. It can be appreciated that the bore 88 is designed to receive the protrusion 68 of the seat portion 56. The width of the bore 88 can be substantially the same as, or slightly less than, the width of the protrusion 68. The upper face 84 of the carrier portion 58 also includes a pair of opposed slots 90. The slots 90 are preferably sized and shaped to correspond with the ridges 76 formed on the lower surface 64 of the body portion 60 of the seat portion 56. Particularly, the ridges 76 formed on the lower surface 64 of the seat portion 56 are received within the slots 90 of the carrier portion 58. In addition to facilitating proper alignment between the seat portion 56 and the carrier portion 58, the ridges 76 and slots 90 can be used to prevent rotation between the seat portion 56 and the carrier portion 58. It should be appreciated that the corresponding ridges 76 and slots 90 could be configured as any suitable mechanism such as a key and groove, or pin and recess, respectively, for aligning and securing the seat portion 56 and carrier portion 58 together.

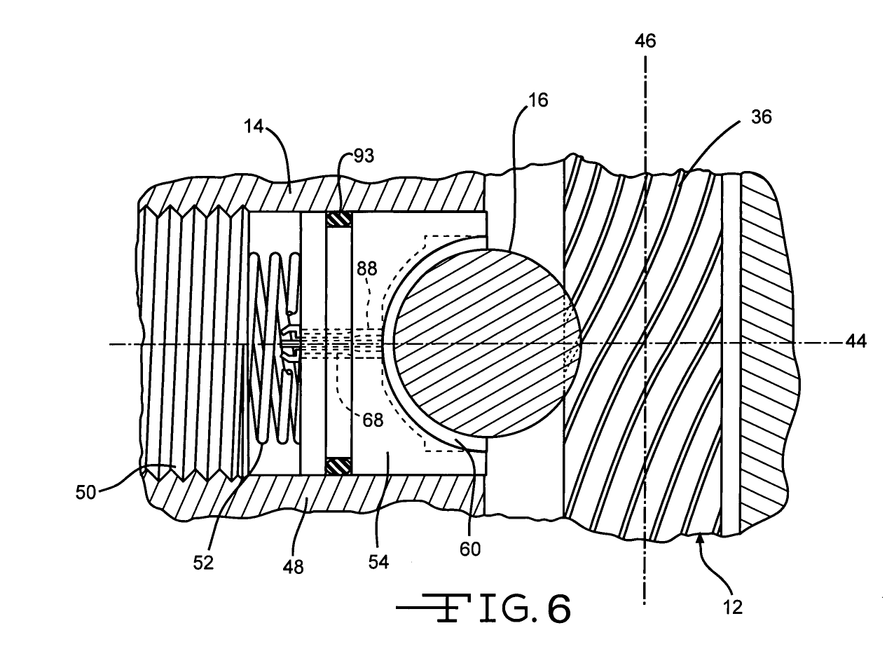

Although the carrier portion 58 has been described as being generally cylindrical, any suitable shape can be used. In addition, in the illustrated embodiment the carrier portion 58 is shown having a lower end 92 having an offset annular flange portion which forms the base 94 of the carrier portion 58. The configuration of the base 94 can vary depending upon the specific design characteristics desired for the carrier portion 58. As illustrated, the base 94 includes a reduced diameter portion 96 relative to the outer diameter of the main body of the carrier portion 58. In the preferred embodiment, the offset annular flange portion which formed the base 94 has substantially the same outer diameter as the main body of the carrier portion 58. However, the base 94 can be configured having a greater or reduced diameter relative to the outer diameter of the main body of the carrier portion 58 as well. The reduced diameter portion 96 is an optional design and is used to optionally support an O-ring (Shown in FIG. 6 at 93). The O-ring would fit entirely within the reduced diameter portion 96. The purpose of the O-ring is to provide stability of the rack yoke assembly 54 within the rack housing 14 since the rack yoke assembly 54 will have large forces working on it from side to side as the rack 16 moves when turning the wheels. Additionally, the O-ring can assist with noise reduction between the rack yoke assembly 54 and the housing 14.

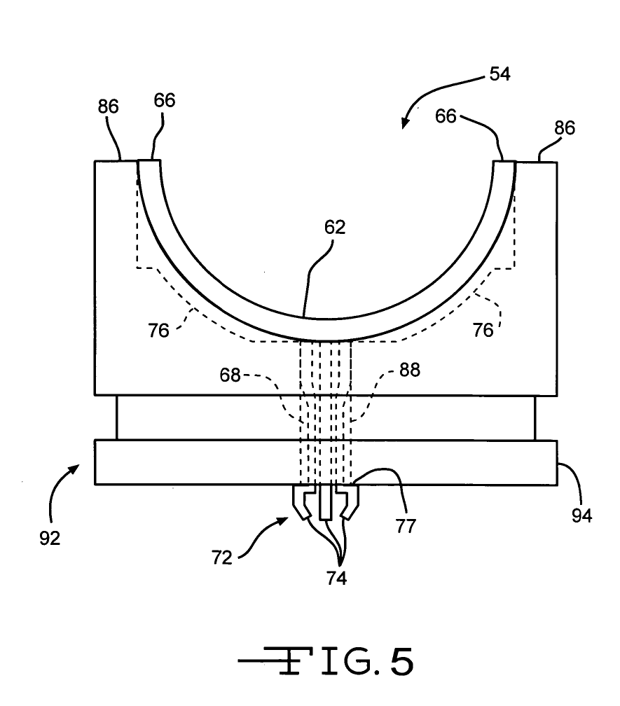

Illustrated in FIG. 4 is a partially assembled rack yoke assembly 54 according to the present invention. Particularly, the prongs 74 of the protrusion 68 of the seat portion 56 can be seen in a slightly compressed position with the space between the prongs 74 being reduced by the wall of the bore 88 in the carrier portion 58. The assembled rack yoke assembly 54 is shown in FIGS. 5 and 6. As can be seen best in FIG. 5, the prongs 74 of the protrusion 68 of the seat portion 56 have resiliently returned (substantially) to their original positions. As can also be seen, the lower ends 72 of the prongs 74 extend through the bore 88 thereby passing through the entire carrier portion 58. In addition, the prongs 74 extend outwardly beyond the width of the bore 88 of the carrier portion 58 thereby locking the seat portion 56 with the carrier portion 58 and forming the rack yoke assembly 54 according to the present invention. It should be appreciated that the seat portion 56 can be attached to the carrier portion 58 by welding, gluing, fastening, frictionally engaging, or by any other suitable mechanism. In addition to the design of the prongs as illustrated in the Figures, it can be appreciated that the ends 72 of the prongs 74 can have any design that facilitates a locking engagement with the bottom of the carrier portion 58. If it is desired that the seat portion 56 be removable from the carrier portion 58 then a locking surface 77 of the ends 72 of the prongs 74 can have a different angle relative to the bottom of the carrier portion 58 such that removal of the seat portion 56 from the carrier portion 58 can be facilitated.

In addition, as an alternative to the prongs 74 being resilient, it can be appreciated that the portion of the prongs 74 extending through the bore 88 of the carrier portion 58 can be bent or otherwise manipulated in order to prevent the separation of the seat portion 56 from the carrier portion 58 after assembly. It is anticipated that the portion of the prongs 74 that extend through the carrier portion 58 will not interfere with the operation of the spring 52 and the rack yoke assembly 54 since the spring 52 is preferably designed to support the base 94 of the rack yoke assembly 54 about the opening of the bore 88 formed in the base 94. In an alternate embodiment, the prongs 74 can extend partway into the bore 88 of the carrier portion 58 and can be supported therein by frictional engagement or within a corresponding recess (not shown) formed within the bore 88, or by a ball and detent design wherein a spring biased ball on the protrusion 68 can be received within the detent in the bore 88 for retaining seat portion 56 with the carrier portion 58. It can be appreciated that any other mechanism for attaching the prongs 74 within the bore 88 can also be used. Alternatively, the protrusion 68 can be formed from a single piece and not comprise a plurality of resilient prongs 74

Illustrated in FIG. 6, there is shown a cross-sectional view of a portion of the rack and pinion steering assembly similar to that which is shown in FIG. 2. The rack yoke assembly 54 according to the present invention is shown within the rack and pinion steering assembly. As can be more clearly seen, the spring 52 is sized to surround the bore 88 of the carrier portion 58 so that the prongs 74 that extend through the bore 88 do not interfere with the position of the spring 52.

It can be appreciated that a rack and pinion steering apparatus for differently sized vehicles can include a racks 16 that have different outer diameters. Therefore, according to the present invention, there is also a system for assembling a seat portion 56 with a carrier portion 58 depending on the size of the rack 16. In the preferred embodiment, the seat portion 56 is sized to closely correspond to the size of the rack 16. Particularly, the rack engaging surface 62 is designed having a curvature that closely matches the outer diameter of the rack 16. Depending on the diameter of the rack 16, a rack yoke assembly 54 is selected wherein the curvature of the rack engaging surface 62 provides the greatest amount of supporting engagement when the rack yoke assembly 54 is forced against the rack 16 by the spring 52. In the preferred embodiment, carrier portions 58 are made having a substantially similar size thereby fitting within the rack housing 14. Therefore, to customize the rack yoke assembly 54 to the selected rack size, a plurality of seat portions 56 can be provided wherein each of the seat portions 56 has a unique size which closely corresponds to the selected rack 16. In order for an assembly operator to identify which seat portion 56 for the rack yoke assembly 54 is to be selected to correspond to the specific rack size, it is preferred that the seat portions 56 have an identifiable physical characteristic to facilitate the identification. In the preferred embodiment, the differently sized seat portions 56 have unique colors, although it can be appreciated that any other physical characteristic can be used for identification purposes such as printing on the surface of the seat portion 56, labels, textures, or other identifying indicia or feature.

The method of assembling the seat portion 56 with the carrier portion 58 is to select the seat portion 56 having the desired structural characteristics that correspond to the rack 16 with which the rack yoke assembly 54 is to be used. The protrusions 68 of the seat portion 56 are then aligned with the bore 88 of the carrier portion 58. There may optionally be a step wherein the prongs 74 of the protrusion 68 are compressed in order to fit the protrusion 68 within the bore 88. The seat portion 56 is then pressed together with the carrier portion 58 until the lower surface 64 of the seat portion 56 is positioned adjacent the upper face 84 of the carrier portion 58. In addition, it is preferred that the ridges 76 formed on the lower surface 64 of the seat portion 56 are received within the slots 90 of the carrier portion 58. In the preferred embodiment, the lower end 72 of the prongs 74 will extend through the bore 88 when the lower surface 64 of the seat portion 56 is properly positioned against the upper face 84 of the carrier portion 58. The prongs 74 will also preferably resiliently expand outwardly substantially to their original positions thereby retaining the seat portion 56 with the carrier portion 58.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A rack yoke assembly for a rack and pinion steering apparatus comprising:
a carrier portion and a seat portion;
wherein the seat portion has an engaging surface that is configured to engage the rack; and
wherein the seat portion and the carrier portion are structured to be assembled together to form the rack yoke assembly.

2. The rack yoke assembly defined in claim 1 wherein the carrier portion includes a bore and the seat portion includes a protrusion;
wherein the protrusion of the seat portion is designed to be received within the bore of the carrier portion to attach the seat portion to the carrier portion.

3. The rack yoke assembly defined in claim 2 wherein the protrusion comprises a plurality of prongs.

4. The rack yoke assembly defined in claim 3 wherein the prongs are resilient.

5. The rack yoke assembly defined in claim 1 further comprising:
a slot formed on an upper face of the carrier portion; and
a ridge formed on a lower surface of the seat portion;
wherein the ridge has a corresponding shape and size to the slot of the carrier portion, the ridge being designed to be received within the slot.

6. The rack yoke assembly defined in claim 1 wherein the carrier portion is capable of receiving one of a plurality of seat portions, each of the seat portions having different sizes such that each seat portion is sized to accommodate differently sized racks.

7. The rack yoke assembly defined in claim 6 wherein each size of the plurality of differently sized seat portions has a unique color.

8. The rack yoke assembly defined in claim 6 wherein each size of the plurality of differently sized seat portions has a unique engaging surface diameter.

9. A system for assembling a rack yoke assembly for a rack and pinion steering apparatus, the rack yoke assembly having a carrier portion and a seat portion, the system having a plurality of differently sized seat portions;
wherein each of the plurality of seat portions has an identifiable physical characteristic; and
one of the plurality of seat portions is selectable to be assembled with the carrier portion to form a rack yoke assembly.

10. The system defined in claim 9 wherein the seat portions of the plurality of seat portions are of different sizes, and each differently sized seat portion is designed to engage a rack having a specified diameter.

11. The system defined in claim 10 wherein the identifiable physical characteristic is a unique color for each size of seat portion.

12. The system defined in claim 10 wherein the identifiable physical characteristic is an indicia on the seat portion indicative of the size of the seat portion.

13. The system defined in claim 9 wherein the seat portions have a protrusion;
the carrier portion has a bore;
wherein the protrusion of one of the seat portions is designed to be received within the bore of the carrier portion to attach the seat portion to the carrier portion.

14. A method for assembling a rack yoke assembly for a rack and pinion steering apparatus comprising:
providing a carrier portion having a bore;
providing a seat portion having a protrusion, the seat portion being configured to engage the rack of a rack and pinion steering apparatus;
inserting the protrusion into the bore to assemble the seat portion with the carrier portion.

15. The method defined in claim 14 wherein the protrusion comprises a plurality of spaced apart prongs.

16. The method defined in claim 15 further comprising the step of:
aligning the prongs of the protrusion with the bore of the carrier portion;
reducing the space between adjacent prongs to fit the prongs within the bore; and
pressing the seat portion and the carrier portion together so that ends of the prongs pass through the bore.

17. The method defined in claim 14 further comprising the steps of:
providing a plurality of seat portions, each of the seat portions having an identifiable physical characteristic; and
selecting one of the seat portions based on a desired identifiable physical characteristic.

18. The method defined in claim 17 wherein the identifiable physical characteristic correlates a seat portion to a particular size of rack.

19. The method defined in claim 14 wherein the seat portion further comprises a ridge formed thereon, the ridge being designed to be received within a slot formed on the carrier portion.

20. The method defined in claim 19 further comprising the step of aligning the ridge formed on the seat portion with the slot of the carrier portion.
